(19) United States
(12) Patent Application Publication
(10) Pub. No.: US 2013/0246167 A1
(43) Pub. Date: Sep. 19, 2013

(54) Cost-Per-Action Model Based on Advertiser-Reported Actions

(71) Applicants: Tao Qin, Beijing (CN); Tie-Yan Liu, Beijing (CN); Wenkui Ding, Beijing (CN); Wei-Ying Ma, Beijing (CN); Hsiao-Wuen Hon, Bellevue, WA (US)

(72) Inventors: Tao Qin, Beijing (CN); Tie-Yan Liu, Beijing (CN); Wenkui Ding, Beijing (CN); Wei-Ying Ma, Beijing (CN); Hsiao-Wuen Hon, Bellevue, WA (US)

(73) Assignee: Microsoft Corporation, Redmond, WA (US)

(21) Appl. No.: 13/421,626

(22) Filed: Mar. 15, 2012

(51) Int. Cl. G06Q 30/02

(52) U.S. Cl. 705/14.46; 705/14.71

(57) ABSTRACT

According to a cost-per-action advertising model, advertisers submit ads with cost-per-action bids. Ad auctions are conducted and winning ads are returned with contextually relevant search results. Each time a winning ad is selected by a user, resulting in the user being redirected to a website associated with the advertiser, a selected impression and a price is recorded for the winning ad. Periodically, an advertiser submits a report indicating a number of actions attributed to the ads that have occurred through the advertiser website. The advertiser is then charged a fee for each reported action based on the recorded prices for the winning ads and based on the number of selected impressions recorded for the winning ads.

### BACKGROUND

Many Internet search engines support paid advertisements, which are displayed contextually with results to user-submitted search queries. In practice, advertisers typically provide the search engine provider with an ad, a keyword, and a bid price. When a user submits a query that includes the keyword, or in some cases a similar keyword, the ad is identified as a candidate ad for display with the search results. There may be, for example, three ad spots available on the search results display and 15 ads that are identified as being contextually relevant candidates. Those 15 ads are then ordered based, at least in part, on the bid price. The top three ads are then selected for display with the search results.

Fees charged to advertisers for such paid advertisements can be determined in different ways. Two common models currently used are cost-per-impression and cost-per-click. According to a cost-per-impression model, an advertiser is charged a fee each time their advertisement is displayed. According to a cost-per-click model, an advertiser is charged a fee each time a user clicks on a displayed advertisement. Many advertisers prefer a cost-per-click model over a cost-per-impression model because they are only charged if a user actually selects their ad, and are thus typically redirected to the advertiser's website.

However, just because a user views an advertiser's website, there is no guarantee that the user will make a purchase or otherwise engage in a transaction with the advertiser. Also, cost-per-click models may be vulnerable to click fraud, which may occur when a competitor searches for and clicks on an ad to increase the cost that the advertiser must pay. Accordingly, there has been increased interest in cost-per-action models, which only charge an advertiser when an action (e.g., a transaction) occurs between a user and the advertiser in response to an ad.

### SUMMARY

This document describes a cost-per-action model for paid search advertising. Ads are submitted with keywords, bid values, and associated actions. When a search query is received, an ad auction is conducted to select one or more ads to be returned as contextually relevant with the query results. Over time, ad auction data is gathered to identify, for example, which ads have won auctions, which winning ads have been selected by users, and prices associated with the winning ads. Periodically, advertisers submit action reports that indicate a number of actions that have occurred that the advertiser attributes to a winning ad. The advertiser is then charged a fee for each reported action based, at least in part, on the gathered ad auction data.

The cost-per-action model may also be combined with a cost-per-click model to create a hybrid model that supports both cost-per-action ads and cost-per-click ads. In the hybrid model, when a cost-per-click ad wins an auction and is subsequently selected by a user, the advertiser is charged for the ad according to the cost-per-click model. Similarly, when a cost-per-action ad wins an auction, is selected by a user, and the advertiser subsequently reports an action associated with the winning cost-per-action ad, the advertiser is charged for the reported action based on the cost-per-action model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an example environment in which a cost-per-action model or a cost-per-action/cost-per-click hybrid model may be implemented.

FIG. 2 is a block diagram of example components of an ad auction module.

FIG. 3 is a flow diagram of an example process for receiving ads, conducting ad auctions, and returning search results with ads according to a cost-per-action model.

FIG. 4 is a flow diagram of an example process for utilizing advertiser-submitted action reports according to a cost-per-action model.

FIG. 5 is a process flow diagram that illustrates processing performed by an example ad auction processing component according to a cost-p er-action model.

FIG. 6 is a process flow diagram that illustrates processing performed by an example ad billing component according to a cost-per-action model.

FIG. 7 is a flow diagram of an example process for receiving ads, conducting ad auctions, and returning search results with ads according to a cost-per-action/cost-per-click hybrid model.

FIG. 8 is a flow diagram of an example process for utilizing advertiser-submitted action reports according to a cost-per-action/cost-per-click hybrid model.

FIG. 9 is a process flow diagram that illustrates an example accounts identification algorithm.

FIG. 10 is a flow diagram of an example process for counteracting advertiser over-reporting.

### DETAILED DESCRIPTION

Paid advertisements that are, for example, displayed contextually along with search results provide a convenient way for advertisers to target their marketing efforts, and provide search engine providers with revenue. In such a system, advertisers bid for available ad spots that are displayed with search results. Typically, the more an advertiser is willing to pay, and thus the higher their bid, the greater chance that their ad will be frequently displayed.

In paid advertisement systems that employ a cost-per-impression model, advertisers are charged a fee each time their advertisement is displayed, regardless of whether or not a user clicks on the ad to be redirected to the advertiser's website. Bid values in cost-per-impression systems are typically fairly low because the return on investment to an advertiser is fairly low per ad that is displayed.

In paid advertisement systems that employ a cost-per-click model, advertisers are charged a fee each time their advertisement is displayed and is selected by a user. Bid values in cost-per-click systems are typically higher than bid values in cost-per-impression systems because the advertiser only pays a fee when a user selects the ad, and is thus redirected to the advertiser's web site. Therefore, for each ad for which the advertiser is charged a fee, there is a higher likelihood that the advertiser will receive revenue or other benefit from an interaction with a user.

To further improve an advertiser's return on investment, a cost-per-action model may be employed in which an advertiser is only charged when a user performs a particular action in response to a particular ad. For example, when a particular ad is displayed and a user clicks on the ad, the user is redirected to the advertiser's website. If the user then makes a purchase from the advertiser's website, according to a cost-per-action model, the advertiser would then be charged a fee for the ad.

Benefits of a cost-per-action model include, for example, higher bid values, and thus potentially higher revenue to the search engine provider; and greater return on investment for advertisers, since the advertisers pay only when an action occurs. However, there are also a variety of challenges to implementing a system based on a cost-per-action model.

One challenge to implementing a cost-per-action model is the inability of search engine providers to directly monitor actions that take place through the advertisers' websites. One possible solution is for search engine providers to insist that advertisers add scripts to the advertisers' websites that will monitor user actions and report back to the search engine. However, many advertisers are reluctant to implement such scripts due to implementation cost and/or privacy concerns.

Another possible solution is for advertisers to adopt a centralized payment service provided by the search engine provider. However, this would give the search engine provider access to detailed information about each transaction conducted through the advertiser's website, which many advertisers would prefer to avoid.

A cost-per-action model that does not require search engine provider access to detailed transaction information of an advertiser is described herein. In the described cost-per-action model, fees charged to advertisers are determined based on advertiser-reported actions. In this system, an advertiser tracks the actions that users take through the advertiser's website and reports numbers of actions to the search engine provider on a regular basis. Based on these reported actions, the search engine provider determines the fees to be charged to the advertiser.

While a cost-per-action model, as described herein, which relies on advertiser-submitted action reports, addresses the implementation cost and privacy concerns of previous cost-per-action models, it may also introduce additional hurdles. For example, if an advertiser were to submit ads with high bid values, their ads will win more ad auctions than ads with lower bid values. If that same advertiser then under-reports the number of actions, the actual cost to the advertiser will be artificially low. Over-reporting by advertisers may also occur, for example, when an advertiser has a large budget and wants to ensure a high rate of ad auction wins.

To address potential under-reporting by advertisers, an average cost-per-action value is maintained for each advertiser, and a threshold value is defined. If an advertiser's cost-per-action value drops below the threshold value, the advertiser may be excluded from future ad auctions.

To address potential over-reporting by advertisers, an estimated average action rate is determined and compared to an action rate reported by the advertiser. If the estimated average action rate is significantly lower than the reported action rate, the reported action rate is modified down to a more reasonable value.

Because many advertisers may be reluctant to adopt a cost-per-action model due to cost and/or privacy concerns raised by existing cost-per-action models, a hybrid model that combines a cost-per-action model with a cost-per-click model is also described herein.

### Example Environment

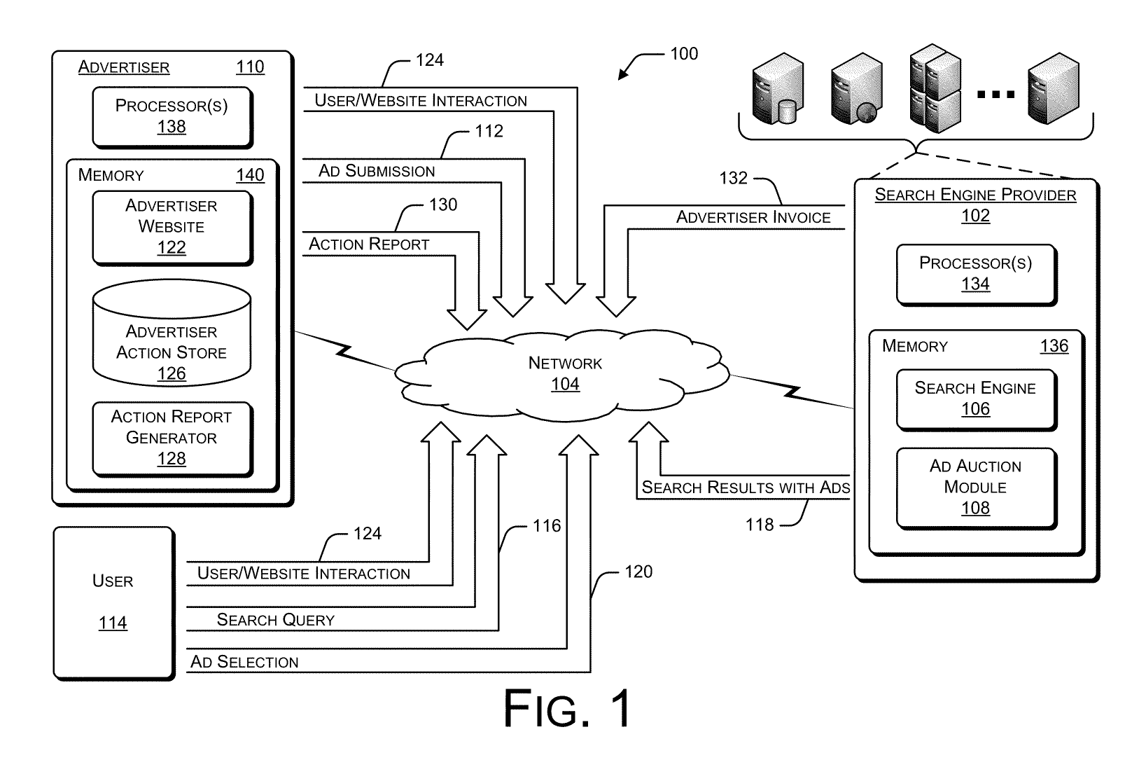

FIG. 1 illustrates an example environment 100 usable to implement a cost-per-action model or a cost-per-action/cost-per-click hybrid model. Example environment 100 includes search engine provider 102 that provides a search service over a network 104, which is representative of, for example, the Internet. In an example implementation, search engine provider 102 may be implemented, for example, as any combination of one or more server computer systems, including, but not limited to, a database server, a web server, an application server, and the like. Example search engine provider 102 includes search engine 106 and ad auction module 108.

In an example scenario, an advertiser 110 sends an ad submission 112 to search engine provider 102. For example, ad submission 112 may include an ad along with an associated bid value, and an associated keyword. If the advertiser will be tracking different types of actions, the ad submission 112 may also include an associated action indicator to distinguish which type of action the ad is to be associated with. Ad submission 112 may also include a redirection URL that specifies a landing page on the advertiser's website to which a user is to be redirected if the user selects the ad. According to the cost-per-action model, the advertiser will only be charged if the ad is displayed and the specified action is reported by the advertiser.

A user 114, desiring to conduct an Internet search, accesses search engine 106, and enters a search query 116 through a user interface provided by search engine 106. Upon receiving search query 116, search engine 106 identifies search results to be presented for the user through the user interface. In addition, ad auction module 108 awards one or more ad spots in a user interface to one or more corresponding ads based, at least in part, on search query 116, the keywords associated with the ads, and the bid values associated with the ads. After ad auction module 108 awards the one or more ad spots to particular ads, search engine 106 returns the search results and ads 118.

Upon viewing the user interface display of the search results with ads 118, user 114 may submit ad selection 120, for example, by clicking on, or otherwise selecting, a particular one of the displayed ads. Search engine provider 102 redirects user 114 to a website 122 associated with the selected ad. The user is specifically redirected to a particular landing page associated with the selected ad within website 122. User 114 then participates in some level of user/website interaction 124. The user/website interaction 124 may be as simple as the user browsing and then leaving the website or may include the user making a purchase, filling out a registration form, or performing any other type of action.

Advertiser 110 monitors user interaction with the advertiser website 122. For example, advertiser 110 maintains a count of specific actions that are performed through the website, specifically actions that are specified in association with ads that are submitted to search engine provider 102. In an example implementation, the advertiser may keep separate counts for actions such as a registration, a purchase, or other actions. In an example implementation, action counts are maintained in advertiser action store 126. Alternatively, action counts may be determined based on data logs that are automatically generated in association with the advertiser website 122.

Periodically (e.g., daily or weekly), action report generator 128 generates a report of actions that have occurred through advertiser website 122 since a previous action report was generated. Action report 130 is then transmitted over network 104 to search engine provider 102.

In response to receiving the advertiser-submitted action report 130, ad auction module 108 stores the reported action counts, and periodically uses the reported action data to generate advertiser invoice 132. The advertiser invoice 132 is then transmitted over network 104, or otherwise communicated to advertiser 110.

As mentioned above, search engine provider 102 may be implemented using any combination of one or more computer systems. In an example implementation, search engine provider 102 includes one or more processors 134, which may be distributed across multiple computing devices. Search engine provider 102 also includes one or more memory components 136.

Search engine 106 an/or ad auction module 108 may be stored, at least in part, in memory 136 as computer readable instructions, which may be executed, at least in part by processor(s) 134.

Similarly, advertiser 110 may be implemented using any combination of one or more computer system, and components thereof may be distributed across multiple computing devices. Example advertiser 110 includes processor(s) 138 and one or more memory components 140. Any portions or combinations of advertiser website 122, advertiser action store 126, and action report generator 128 may be stored in memory 140 as computer readable instructions, which may be executed, at least in part by processor(s) 138.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

As illustrated in FIG. 1, memory components 136 and 140 are examples of computer storage media.

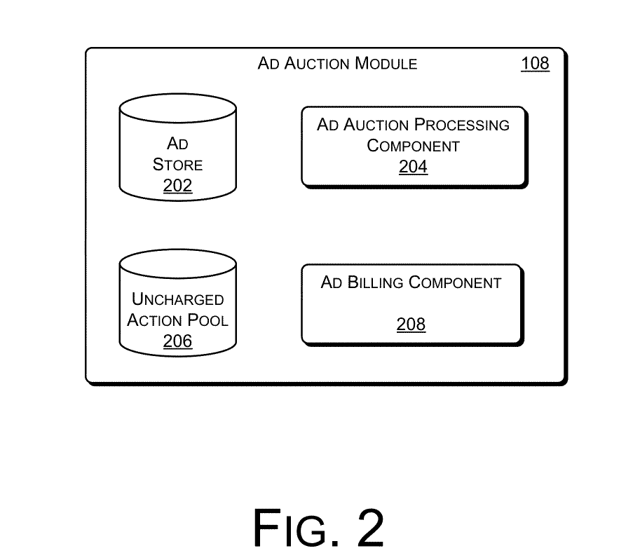

FIG. 2 illustrates components of an example ad auction module 108. Example ad auction module 108 includes, but is not limited to, any combination of ad store 202, ad auction processing component 204, uncharged action pool 206, and ad billing component 208.

When search engine provider 102 receives an ad submission 112 from an advertiser, the ad and related information is stored in ad store 202. When search engine provider 102 receives search query 116, ad auction processing component 204 conducts an ad auction to identify ads to be returned with the query results. Data indicating which ads were winners of which auctions, which ads have been selected by users, and any other ad auction related statistical information may also be stored, for example, in ad store 202.

As described above with reference to FIG. 1, advertiser 110 periodically sends an action report 130 to search engine provider 102. When an action report is received, the indicated action counts are added to uncharged action pool 206. Periodically, ad billing component 208 analyzes the action counts in uncharged action pool 206, along with ad auction related statistical information, to generate invoice 132 for the advertiser.

### Example Cost-Per-Action Model Operation

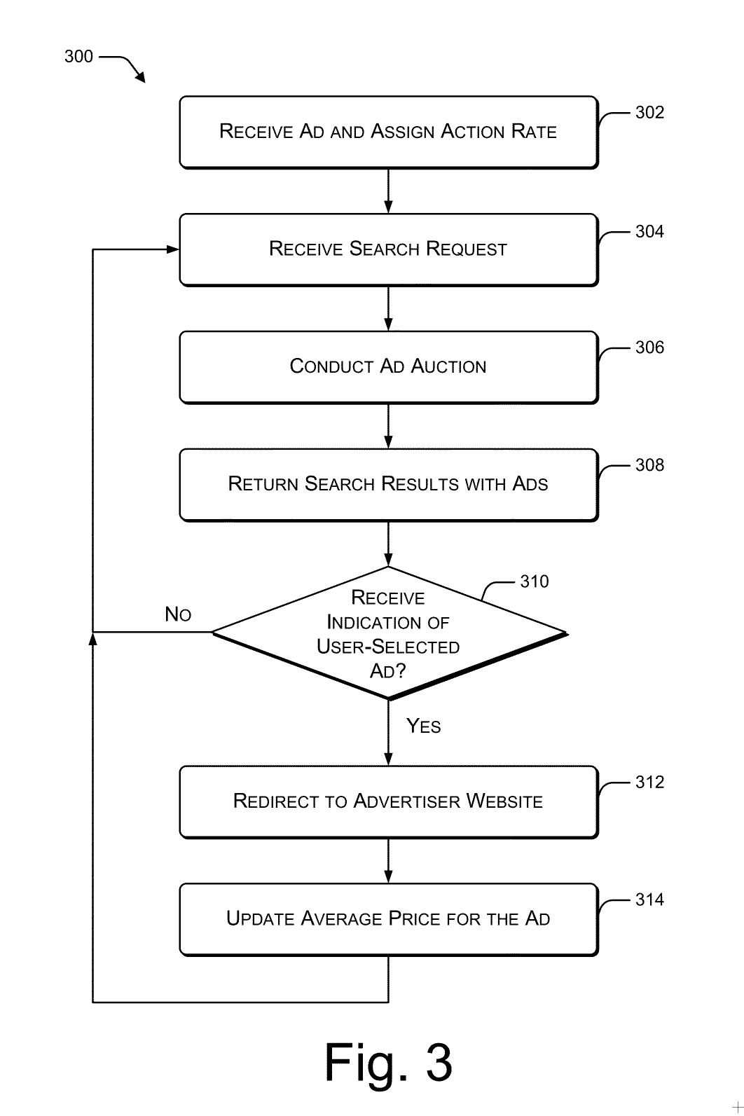

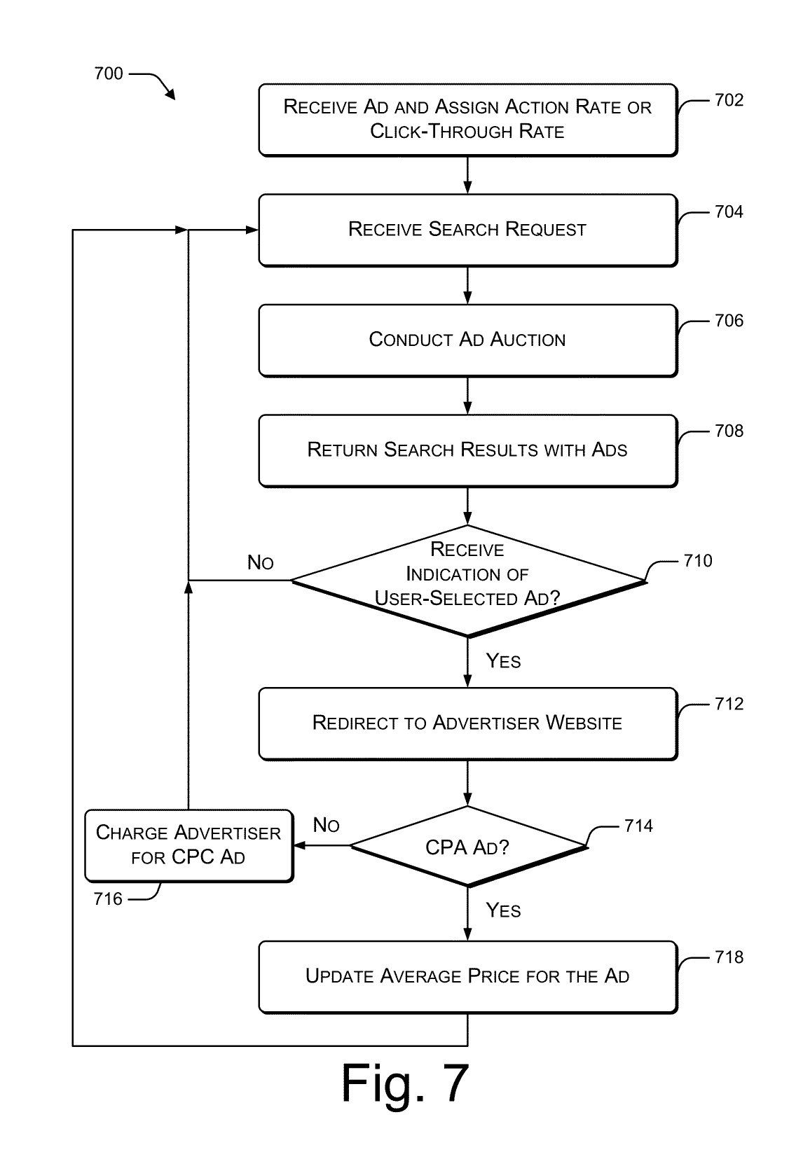

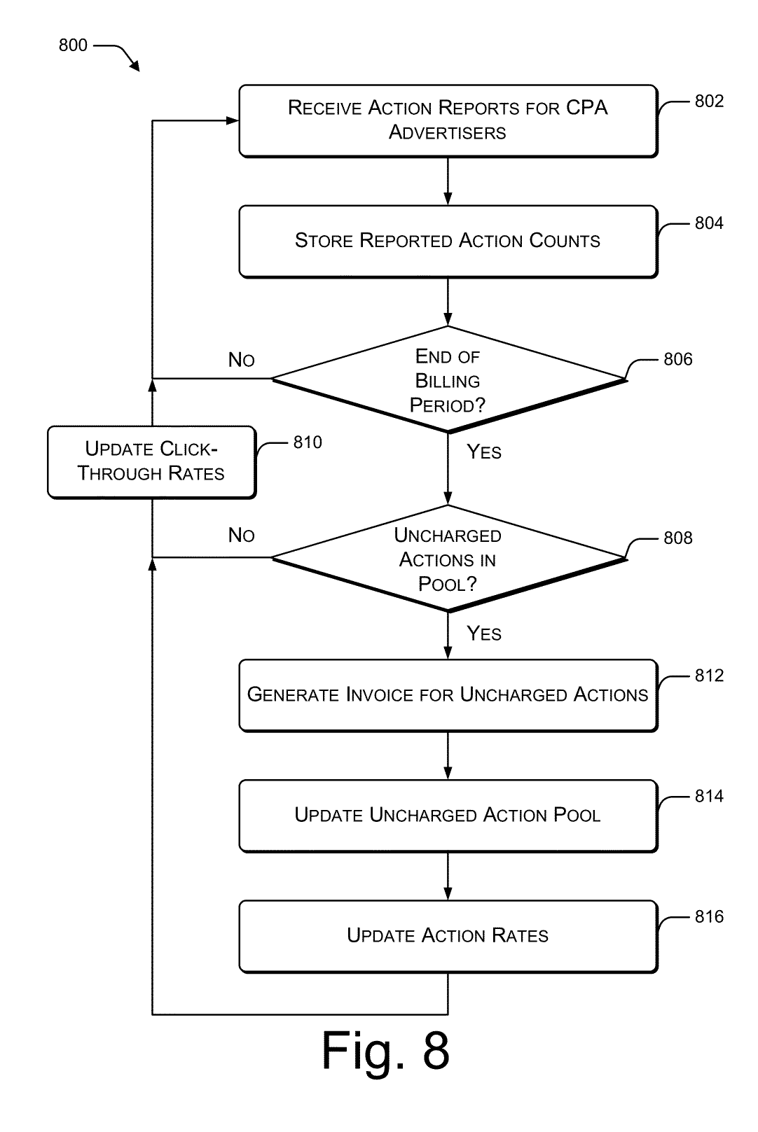

FIGS. 3-8 illustrate example operation processes 300, 400, 500, 600, 700, and 800 of search engine provider 102. FIGS. 3-6 are directed to a cost-per-action model while FIGS. 7 and 8 are directed to a cost-per-action/cost-per-click hybrid model. These processes are illustrated as collections of blocks in logical flow graphs, which represent sequences of operations that can be implemented in hardware, software, or a combination thereof. In the context of software, the blocks represent computer-executable instructions that may be stored on one or more computer storage media that may be executed by one or more processors to cause the processors to perform the recited operations. Note that the order in which the processes are described is not intended to be construed as a limitation, and any number of the described process blocks can be combined in any order to implement the illustrated processes, or alternate processes. Additionally, individual blocks may be deleted from the processes without departing from the spirit and scope of the subject matter described herein. Furthermore, while these processes are described with reference to the search engine provider 102 described above with reference to FIGS. 1 and 2, other computer architectures may implement one or more portions of these processes, in whole or in part.

FIG. 3 illustrates an example process for receiving ads, conducting ad auctions, and returning search results with ads according to a cost-per-action model.

At block 302, an ad is received and an action rate is assigned to the ad. For example, ad submission 112 is received from advertiser 110. In an example implementation, the ad submission 112 that is received may include an <ad, keyword, action, bid value> tuple. The bid value represents a maximum amount that the advertiser is willing to pay when the ad is presented with search results (e.g., ad impression), the ad is selected by a user (e.g., selected impression), and the specified action occurs through advertiser website 122.

Over time, the action rate for any particular ad is calculated to represent a ratio of the number of reported actions to the number of selected impressions of the ad. For example, if a particular ad has “purchase” as the associated action, the ad has been selected by users 600 times, and the advertiser reports 75 purchases, then the action ratio for the ad may be calculated as 75/600 or 0.125.

However, when an ad is first received, there is no data with which to calculate an action rate, so the action rate for the ad is initialized to a pre-determined value. In an example implementation, the same pre-determined value may be used for all new ads. In an alternate implementation, the ad auction module may utilize a machine learning method to consider other factors (e.g., keyword, action, and/or bid value) associated with the ad to determine an initial action rate for the ad. Machine learning methods are commonly used in existing cost-per-click models to predict click-through rates for ads, and similar machine learning methods can be employed to initialize action rates in the cost-per-action model.

At block 304, a search request is received. For example, search query 116 is received from user 114 over network 104. The search query may be, for example, a word or phrase against which an Internet search is to be conducted.

At block 306, an ad auction is conducted. For example, ad auction processing component compares the received search request with keywords associated with ads in ad store 202 to identify candidate ads based on contextual relevance to the search query. The candidate ads are then ordered based, at least in part, on bid value, and a winning ad for each available ad slot is determined. A common cost-per-click model employs a generalized second price auction, which ranks ads according to their expected revenue, which, in a cost-per-click model, is equal to the predicted click probability of an ad multiplied by the bid price associated with the ad. In the described cost-per-action model, a similar approach may be used. In an example implementation of the described cost-per-action model, candidate ads are also ordered by their expected revenue. However, instead of multiplying the bid price by a predicted click probability, the expected revenue is calculated as the action rate multiplied by the bid price. As described herein, the bid value multiplied by the action rate is referred to as a ranking score for cost-per-action ads.

At block 308, search results with ads are returned. For example, the results of an Internet search based on the search query 116, along with the winning ad for each available ad slot is returned to the user.

At block 310, a determination is made regarding whether or not an indication of a user-selected ad is received. If no indication of a user-selected ad is received (the “No” branch from block 310), then processing continues as described above with reference to block 304.

Alternatively, at block 310, an indication of a user-selected ad may be received. For example, while viewing the search results, user 114 may click on a particular ad that is displayed along with the search results.

When an indication of a user-selected ad is received (the “Yes” branch from block 310), then at block 312, the user is redirected to a landing page within a website associated with the selected ad (e.g., advertiser website 122), and at block 314, an average price for the ad is updated. In an example implementation, each time an ad is selected by a user, a number of selected impressions (i.e., clicks) of the ad is incremented by one. In addition, a price for the ad is determined. The average price for the ad is calculated as the total number of selected impressions that an ad receives in a particular time period divided by the sum of the prices determined for the ad in association with each of the selected impressions. In an example implementation, the price determined for a selected ad may be equal to the bid price associated with the ad. In an alternate implementation, as is done in generalized second price auctions (common in cost-per-click models), the price for a selected ad may be determined according to the second-price-rule to be the minimum bid price required to keep the ad in its calculated rank position. Accordingly, if a particular ad wins multiple ad auctions within a single time period, the determined price for the ad may be different for each auction.

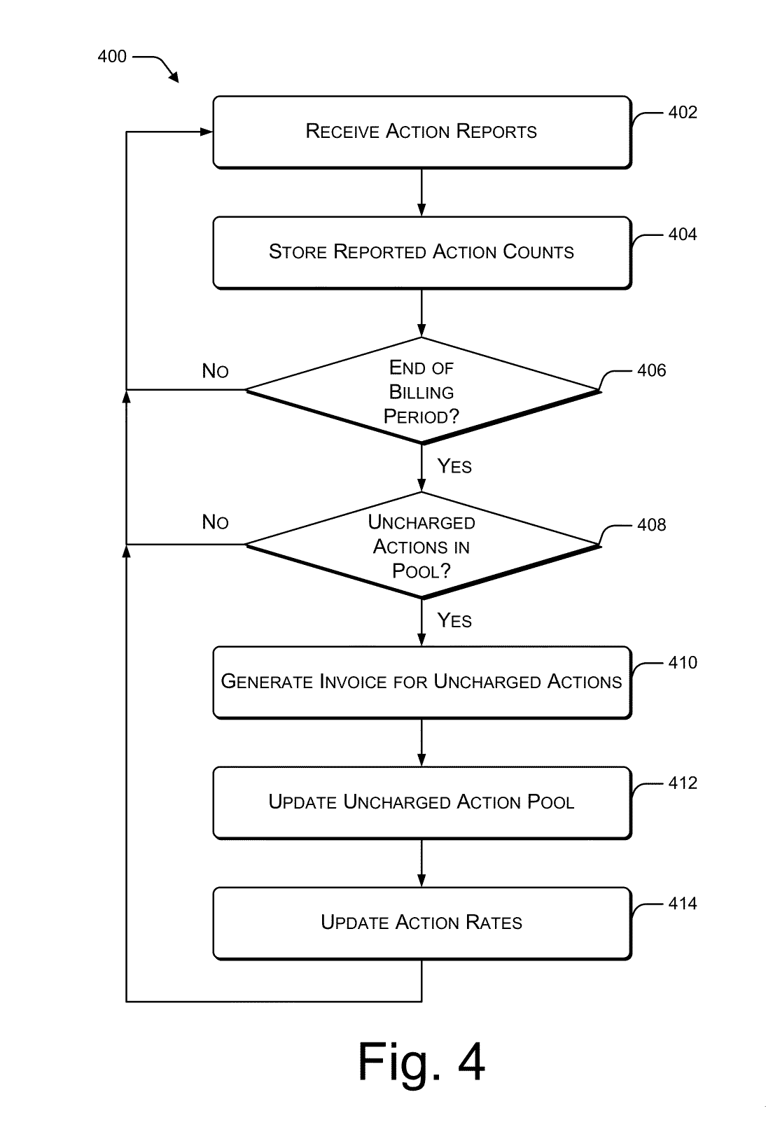

FIG. 4 illustrates an example process for utilizing advertiser-submitted action reports according to a cost-per-action model.

At block 402, one or more action reports are received from one or more advertisers. For example, advertiser 110 periodically submits action report 130 to search engine provider 102. The action report indicates an aggregated count of actions that the advertiser attributes to an ad having been returned with search results from search engine provider 102 and then selected by a user.

At block 404, the action counts reported in the action reports are stored. For example, the aggregated counts are added to uncharged action pool 206.

At block 406, a determination is made as to whether or not the end of a billing period has been reached. A billing period may be defined as any period of time. In an example implementation, each billing period may be one day. In an alternate implementation, each billing period may be one week. Any length of time may be defined as a billing period. However, if a billing period is too short, the advertisers may not have submitted very many action reports since the previous billing period. Also, if the billing period is too long, the action rates associated with the advertisers may be updated more infrequently than is desired.

If the end of the billing period has not been reached (the “No” branch from block 406), then processing continues as described above with reference to block 402.

On the other hand, if the end of the billing period has been reached (the “Yes” branch from bock 406), then at block 408 a determination is made as to whether or not there are uncharged actions in the uncharged action pool. For example, if no action reports have been received from any of the advertisers since the end of the last billing period, then there will be no uncharged actions in the uncharged action pool. However, if there have been one or more action reports received from one or more advertisers, then there will be uncharged actions in the uncharged action pool.

If there are no uncharged actions in the uncharged action pool (the “No” branch from block 408), then processing continues as described above with reference to block 402.

On the other hand, if there are uncharged actions in the uncharged action pool (the “Yes” branch from block 408), then at block 410, an invoice for the uncharged actions is generated. For example, as indicated in block 314 of FIG. 3, each time an ad is selected, an average price for the ad is updated based on prices determined for the ad each time the ad won an auction. To generate an invoice, the average price for the ad is multiplied by the number of uncharged actions that are associated with the ad.

At block 412, the uncharged action pool is updated. For example, after a charge for a particular action has been calculated and added to the invoice, the action is removed from the uncharged action pool, or otherwise marked within the uncharged action pool as having been charged.

At block 414, ad action rates are updated. For example, for each ad, the number of reported actions is added to an aggregate number of reported actions over time, a number of selected impressions of the ad within the most recent time period is added to a an aggregate number of selected impressions of the ad, and the action rate for the ad is recalculated.

### Example Cost-Per-Action Model Calculations

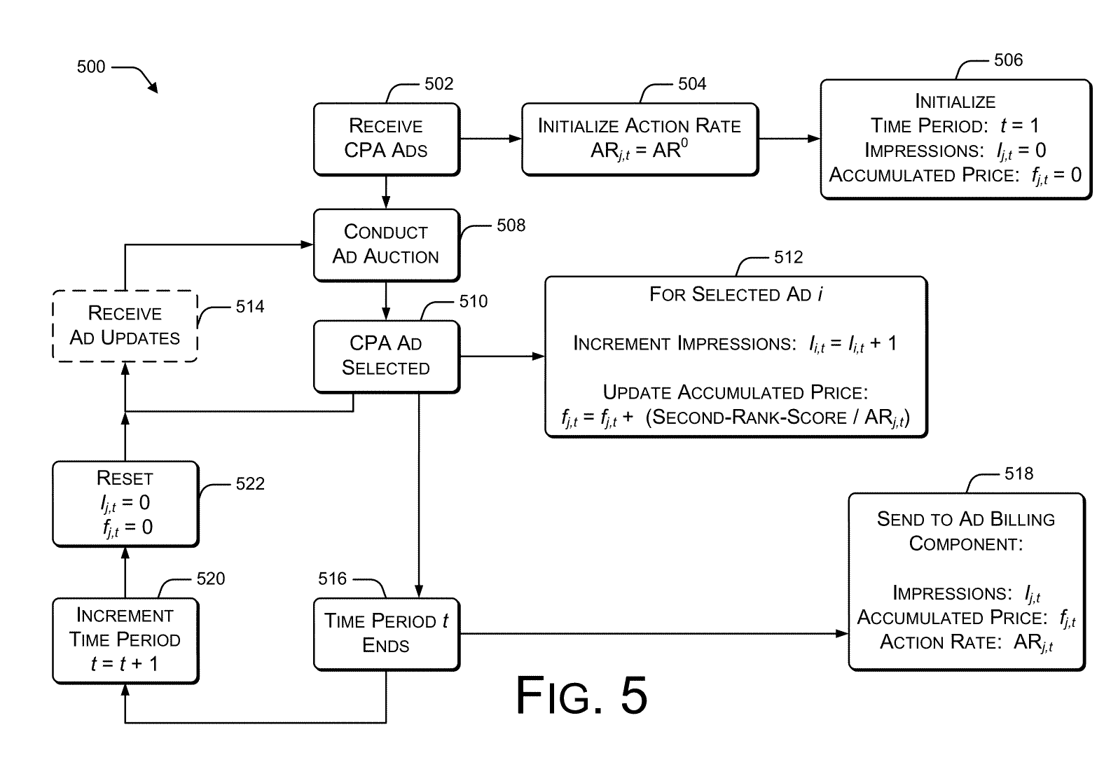

FIG. 5 illustrates processing 500 performed by example ad auction processing component 204 according to the cost-per-action model described herein.

At block 502, ad auction module 110 receives cost-per-action ads. For example, one or more advertisers submit ads for which the advertiser is willing to pay a fee when the ad is returned with contextually relevant search results, selected by a user, and a particular action subsequently occurs through the advertiser's website. As described above, the ads are stored in ad store 202.

At block 504, for each ad, an action rate for the ad is initialized. In the illustrated example, AR_{j,t} is the action rate for a particular ad j during a particular time period t. AR⁰ represents the initialization value, which may be determined according to known machine learning methods. Accordingly, as shown in block 504, AR_{j,t}=AR⁰.

At block 506, for each ad, a time period t is initialized to one (t=1), and a number of selected impressions I_{j,t} and an accumulated price f_{j,t} are each initialized to zero (I_{j,t}=0 and f_{j,t}=0). Time periods last a pre-defined period of time. In an example implementation, each day is a new time period. In an alternate implementation, the time period may be defined as one week, one hour, 12 hours, or any other pre-defined period of time.

At block 508, an ad auction is conducted. As described above, each ad has an associated keyword, an associated action, and an associated bid value. Within the ad auction, candidate ads are selected based on the keyword associated with the ad. The candidate ads are then ordered by a rank score, which is equal to the current action rate for the ad (AR_{j,t}) multiplied by the current bid associated with the ad (b_{j,t,τ}), where τ represents the current auction. The bid value is distinguished by ad, time period, and auction because advertisers can change bid values at any time. As such, within the same time period, the same ad may have different bid values. For each available ad slot, a winning ad is selected and returned with results of a user-submitted search query.

At block 510, an ad is selected by a user. For example, ad auction processing component receives an indication that a user has selected one of the ads that was returned with the search results.

At block 512, in response to a particular ad i being selected, the number of selected impressions for the ad within the current time period is incremented. (I_{i,t}=I_{i,t}+1) and an accumulated price associated with the ad is updated. The accumulated price is increased by an amount equal to a price to be charged for the selected ad if the ad selection results in the action associated with the ad. In an example implementation, the price to be charged for the selected ad is determined according to a second-price rule. As described above, according to the second-price rule, the price to be charged for the selected ad is the minimum bid price required to keep the given ad in its current rank position. For example, the rank of the second ad (the first ad that did not win the ad auction) is used to determine the price for the selected ad such that the price for the selected ad is equal to the rank score of the second ad divided by the action rate of the selected ad. In an alternate implementation that does not employ the second-price rule, the accumulated price may simply be increased by the current bid value, b_{i,t,τ}.

At block 514, updates to the ads may be received. For example, bid values associated with ads may be updated by the respective advertisers and/or ads may be removed by the respective advertisers.

The processing illustrated in blocks 508-514 are repeated iteratively until the current time period ends. In addition, new ads may be received at any time, the processing for which is described with reference to blocks 502-506.

At block 516, the current time period ends. For example, if a time period is defined as one day, then at block 516 the end of the day is reached.

At block 518, in response to the time period ending, for each ad, the number of selected impressions for the time period I_{j,t}, the accumulated price for the time period f_{j,t}, and the action rate for the current time period AR_{j,t} are sent to the ad billing component 208.

Also in response to the time period ending, at block 520, time period t is incremented (t=t+1), and at block 522, the number of selected impressions and the accumulated price for each ad is reset to zero for the new time period (I_{j,t}=0 and f_{j,t}=0). Processing then continues as described above with reference to block 514.

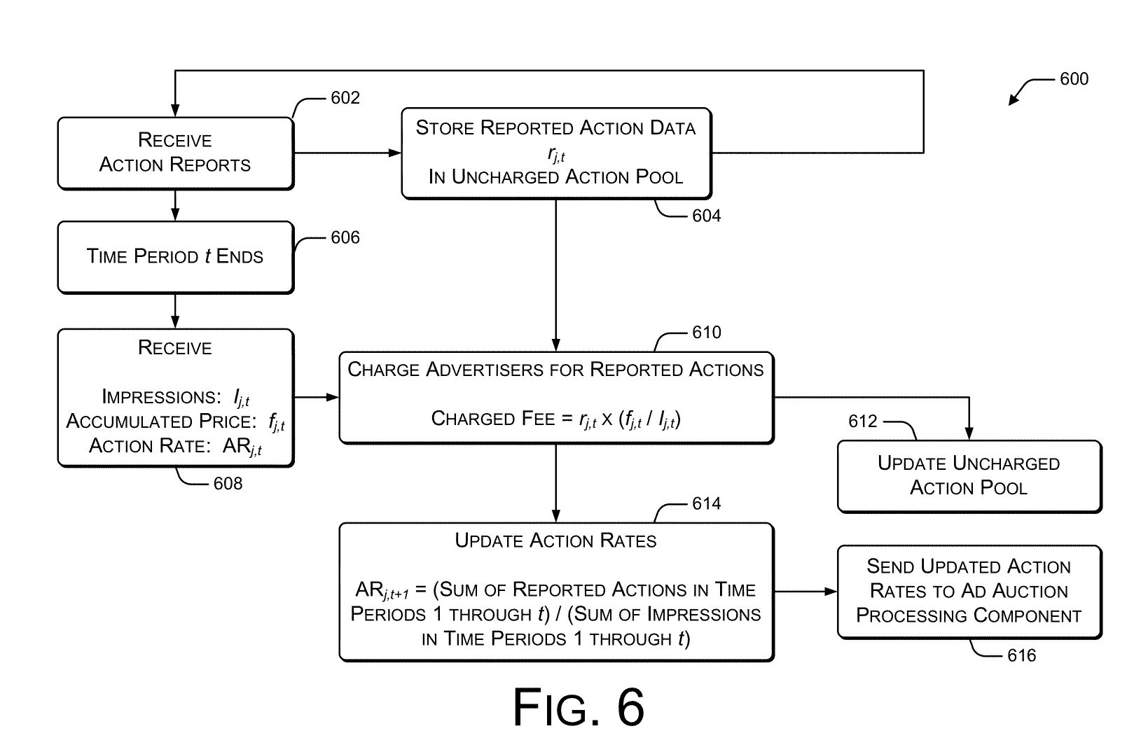

FIG. 6 illustrates processing 600 performed by example ad billing component 208 according to the cost-per-action model described herein.

At block 602, ad billing component 208 receives action reports from one or more advertisers. Each action report is received from an advertiser, and indicates how many actions have occurred through the advertiser's website since the advertiser last submitted an action report. In an example implementation, for each reported action, the action report indicates the ad to which the action is attributed. In an exemplary implementation, reported actions are assumed to have occurred during the most recent previous time period (e.g., if each time period is one day, any actions reported today are assumed to have occurred yesterday). In an alternate implementation, action reports may also indicate a specific date and/or time at which the action occurred.

Various techniques may be used by advertisers to attribute actions to specific ads. If a user selects an ad, is redirected to the advertiser's website, and during that visit performs the action, then the action can easily be attributed to the ad. However, users will often select an ad, be redirected to the advertiser's website, browse the website, and then leave the website. The user may then later return to the advertiser's website directly (not through redirection from an ad) and perform the action. In this case, the action should still be attributed to the ad, but such attribution is much more difficult to determine.

Because it is difficult to accurately attribute actions to ads, in an example implementation, advertisers can calculate an overall action rate for their website (or for each landing page within the website), and use this overall action rate to determine the number of actions to report to the search engine. For example, usage logs enable an advertiser to see a reference page from which a user arrived at the website. Accordingly, based on the usage logs, the advertiser is able to determine a total number of user visits and a number of visits attributable to a particular search engine. The overall action rate for the website can be calculated as the total number of actions divided by the total number of user visits. Next, multiplying this overall action rate by the number of visits that are attributed to the search engine gives a reasonable number of actions to be reported as attributed to an ad from the search engine. If the advertiser submits ads for different action types, a similar method may be used to attribute actions to ads, but instead of calculating an overall action rate for the website, an overall action rate is calculated for each action type.

At block 604, the reported action data is stored in uncharged action pool 206. In the illustrated example, the reported actions that are attributed to a particular ad j during a particular time period t are represented as r_{j,t}.

At block 606, which corresponds to block 516 of FIG. 5, time period t ends. In response, at block 608, which corresponds to block 518 of FIG. 5, ad billing component 208 receives, for each ad j during time period t, the number of selected impressions I_{j,t}, the accumulated price f_{j,t}, and the action rate AR_{j,t}.

At block 610, the advertisers are charged for their reported actions. In the illustrated example, for each ad with corresponding reported actions, the average price per reported action is calculated as the accumulated price f_{j,t} divided by the number of selected impressions I_{j,t}. The advertiser is then charged a fee equal to the number of reported actions r_{j,t} multiplied by the average price per reported action.

After the advertisers are charged, at block 612 the uncharged action pool is updated. For example, each action for which the advertiser has been charged is removed from the uncharged action pool. In an alternate implementation, rather than removing the reported actions from the uncharged action pool, the reported actions for which the advertiser has been charged are marked as charged within the uncharged action pool.

After the advertisers are charged, in addition to updating the uncharged action pool, at block 614 the ad billing component 208 updates the action rates associated with each ad. In the illustrated example, for each ad, the action rate for the next time period AR_{j,t+1} is set equal to the total number of reported actions in time periods 1 through t divided by the total number of selected impressions in time periods 1 through t. This may be expressed as:

$${AR}_{j , t + 1} = \frac{{{\sum }_{s = 1}}^{t} {r}_{j , s}}{{\sum }_{s = 1}^{t} {I}_{j , s}}$$

In an alternate implementation, to prevent a low number of reported actions in the early time periods for an ad from negatively impacting the action rate for the ad, the action rate for the next time period may be calculated based on the advertiser's historical reports and smoothed by the initial action rate value. Accordingly, the action rate for the next time period may be expressed as:

$${AR}_{j , t + 1} = {α}_{t} \frac{{\sum }_{s = 1}^{t} {r}_{j , s}}{{\sum }_{s = 1}^{t} {I}_{j , s}} + ( 1 - {α}_{t} ) {AR}^{0}$$

where αₜ is a tradeoff factor that increases to 1 as t increases to infinity. Accordingly, the longer the ad is in the system, the less the initial action rate will impact the calculated new action rate.

Another alternate calculation of the action rate for the next time period weights performance during recent time periods more heavily than performance during earlier time periods. According to this method, the action rate for the next time period may be expressed as:

$${AR}_{j , t + 1} = {α}_{t} \frac{{\sum }_{s = 1}^{t} {δ}_{t - s} {r}_{j , s}}{{\sum }_{s = 1}^{t} {δ}_{t - s} {I}_{j , s}} + ( 1 - {α}_{t} ) {AR}^{0}$$

where αₜ is a tradeoff factor that increases to 1 as t increases to infinity and δₜ is a decreasing function of its index t. In an example implementation, δₜ=0.9^{t}.

At block 616, the updated action rates for each ad are sent back to ad auction processing component 616.

### Example Cost-Per-Action/Cost-Per-Click Hybrid Model Operation

As mentioned above, advertisers may be somewhat reluctant to fully adopt a cost-per-action advertising model. A cost-per-action/cost-per-click hybrid model is implemented to allow a gradual move from a more familiar cost-per-click model to a less familiar cost-per-action model. In the described hybrid model, advertisers can submit bids based on a cost-per-click model and/or bids based on a cost-per-action model. Advertisers can even submit the same ad/keyword pair twice—once as a cost-per-click ad and again as a cost-per-action ad. In addition to providing a way for advertisers to “try out” a cost-per-action model without having to fully commit to a move away from a cost-per-click model, the hybrid model may also provide other benefits for advertisers. For example, if a goal for a particular ad campaign is to increase brand awareness, the advertiser may choose to submit the ad as a cost-per-click ad, where the goal is to receive as many clicks as possible. On the other hand, if a particular ad campaign has a direct response goal, then the advertiser may choose to submit the ad as a cost-per-action ad.

FIG. 7 illustrates an example process for receiving ads, conducting ad auctions, and returning search results with ads according to a cost-per-action/cost-per-click hybrid model. The process illustrated in FIG. 7 is very similar to the process illustrated in FIG. 3, but with the addition of processing to handle cost-per-click ads in addition to the cost-per-action ads.

At block 702, an ad is received and an action rate or click-through rate is assigned to the ad. For example, ad submission 112 is received from advertiser 110. With the hybrid model, advertisers may submit cost-per-action ads and/or cost-per-click ads. In an example implementation, the ad submission 112 that is received may include an <ad, keyword, action, bid value> tuple for a cost-per-action ad or an <ad, keyword, bid value> tuple for a cost-per-click ad. For a cost-per-action ad, the bid value represents a maximum amount that the advertiser is willing to pay when the ad is presented with search results, selected by a user, and the specified action occurs through advertiser website 122. For a cost-per-click ad, the bid value represents a maximum amount that the advertiser is willing to pay when the ad is presented with search results and a user selects (e.g., clicks on) the ad.

As described above with reference to FIG. 3, the action rate for any particular cost-per-action ad is calculated to represent a ratio of the number of reported actions to the number of selected impressions of the ad; and when a new cost-per-action ad is received, the action rate is initialized to a pre-determined value or to a value which may be based on a machine learning method. Similarly, the click-through rate for any particular cost-per-click ad is calculated to represent a ratio of the number of click-throughs received to the number of auctions won by the ad. When a new cost-per-click ad is received, the click-through rate is initialized to a pre-determined value or to a value which may be based on a machine learning method, as is common in existing cost-per-click models.

At block 704, a search request is received. For example, search query 116 is received from user 114 over network 104. The search query may be, for example, a word or phrase against which an Internet search is to be conducted.

At block 706, an ad auction is conducted. For example, ad auction processing component compares the received search request with keywords associated with ads in ad store 202 to identify candidate ads based on contextual relevance to the search query. According to the hybrid model, both cost-per-click ads and cost-per-action ads are considered in the ad auction. The candidate ads are then ordered by a ranking score. For cost-per-action ads, the ranking score is equal to the bid value multiplied by the action rate. For cost-per-click ads, the ranking score is equal to the bid value multiplied by the click-through-rate. In an example implementation, if the same ad has been submitted as both a cost-per-click ad and as a cost-per-action ad, the ad with the lower ranking score is removed from the candidate ads to prevent two identical ads from being returned with the search results.

At block 708, search results with ads are returned. For example, the results of an Internet search based on the search query 116, along with the winning ad for each available ad slot is returned to the user. The ads that are retuned with the search results may include any number of cost-per-click ads and/or any number of cost-per-action ads.

At block 710, a determination is made regarding whether or not an indication of a user-selected ad is received. If no indication of a user-selected ad is received (the “No” branch from block 710), then processing continues as described above with reference to block 704.

Alternatively, at block 710, an indication of a user-selected ad may be received. For example, while viewing the search results, user 114 may click on a particular ad that is displayed along with the search results.

When an indication of a user-selected ad is received (the “Yes” branch from block 710), then at block 712, the user is redirected to a website associated with the selected ad (e.g., advertiser website 122).

At block 714, a determination is made as to whether the selected ad is a cost-per-click ad or a cost-per-action ad. If the selected ad is a cost-per-click ad (the “No” branch from block 714), then at block 716, the advertiser is charged for the cost-per-click ad and processing then continues as described above with reference to block 704. Any number of techniques may be used to charge the advertiser for a cost-per-click ad. In an example implementation, the charge for the clicked ad may be immediately sent to the advertiser. In an alternate implementation, cost-per-click charges may be accumulated and advertisers may be notified of the charges per periodic invoices.

The amount charged for the user-selection of a cost-per-click ad may be equal to the bid price. Alternatively, the amount charged may be determined according to the second-price rule, such that the charge is equal to the minimum bid required to keep the ad in its current rank position.

On the other hand, if at block 714 it is determined that the ad is a cost-per-action ad (the “Yes” branch from block 714), then at block 718, the average price for the ad is updated according to the cost-per-action model, as described above with reference to block 314 of FIG. 3.

FIG. 8 illustrates an example process for utilizing advertiser-submitted action reports to generate invoices and update action rates in a cost-per-action/cost-per-click hybrid model. The process illustrated in FIG. 8 is very similar to the example process illustrated in FIG. 4.

At block 802, as with block 402 of FIG. 4, one or more action reports are received from one or more advertisers. As described above with reference to FIG. 6, various techniques may be used by advertisers to attribute actions to specific ads. The cost-per-action/cost-per-click hybrid model adds another level of complexity to the ad/action attribution because a distinction must be made between actions that may result from user selection of a cost-per-click ad (for which the advertiser should not be charged) and actions that result from user selection of a cost-per-action ad (for which the advertiser should be charged).

In one example implementation, the search engine encodes an ad identifier in the redirection URL. With this information, advertisers can determine which user visits are the results of which ads. The advertiser can then use this information to calculate an action rate for the website that is associated with cost-per-click ads and an action rate for the website that is associated with cost-per-action ads. The action rate for the cost-per-action ads can then be used to calculate a number of actions that are attributed to the cost-per-action ads.

In an alternate example, advertisers report the number of actions that they attribute to redirection from the search engine (as described above with reference to the cost-per-action model), and the search engine provider charges the advertiser based on a ratio of selected cost-per-action ads to a sum of selected cost-per-action ads and selected cost-per-click ads. For example, if a particular cost-per-click ad receives 1000 clicks and a corresponding cost-per-action ad receives 3000 clicks, then there are 4000 user-selections of the ad that may have led to an action. 25% of those are attributed to the cost-per-click ad (i.e. 1000/4000) and 75% of those are attributed to the cost-per-action ad. Accordingly, the advertiser will only be charged for 75% of the reported actions. For example, given the scenario described just above, if the advertiser reports 8 actions, then the advertiser is charged the average price per ad multiplied by 6 (75% of 8). This may also be expressed as:

Fee Charged=(f_{j,t}/I_{j,t})(r_{j,t})(I_{j,t}/(c_{j′,t}+I_{j,t}))

where f_{j,t} is the accumulated price for the cost-per-action ad, I_{j,t} is the number of selected impressions associated with the cost-per-action ad, r_{j,t} is the total number of reported actions, and c_{j′,t} is the number of click-throughs received by ad j′, which is the cost-per-click ad that corresponds to the cost-per-action ad.

At block 804, as with block 404 of FIG. 4, the action counts reported in the action reports are stored.

At block 806, as with block 406 of FIG. 4, a determination is made as to whether or not the end of a billing period has been reached.

If the end of the billing period has not been reached (the “No” branch from block 806), then processing continues as described above with reference to block 802.

When the end of the billing period is reached (the “Yes” branch from block 806), then at block 808, as with block 408 of FIG. 4, a determination is made as to whether or not there are uncharged actions in the uncharged action pool.

If there are no uncharged actions in the uncharged action pool (the “No” branch from block 808), then at block 810, the click-through rates for any cost-per-click ads are updated and processing continues as described above with reference to block 802. As described above, the click-through rate of a cost-per-click ad is calculated as the ratio of click-throughs to auctions won for each particular cost-per-click ad.

If there are uncharged actions in the uncharged action pool (the “Yes” branch from block 808), then at block 812, as with block 410 of FIG. 4, an invoice for the uncharged actions is generated.

At block 814, as with block 412 of FIG. 4, the uncharged action pool is updated.

At block 816, as with block 414, of FIG. 4, the action rates for the cost-per-action ads are updated.

The example calculations illustrated in and described above with reference FIGS. 5 and 6 are also used in conjunction with the cost-per-action ads in the cost-per-action/cost-per-click hybrid model.

### Addressing Untruthful Action Reports

With the cost-per-action model described herein, there are some ways in which advertisers may attempt to increase their return on investment through untruthful action reports. Fraud may occur when advertisers either under-report the number of actions or over-report the number of actions.

When an advertiser under-reports, they may, for example identify 10 actions within a particular time period, but only report (and thus only pay for) 5 or even fewer. One technique for dealing with this type of behavior that is built into the cost-per-action model described herein is the use of the action rate in calculating the rank score. Accordingly, over time, advertisers who under-report will have a lower than accurate action rate, which will, over time, negatively affect the ad's ability to win ad auctions.

Another technique that may be implemented to further deal with under-reported actions is to use threshold values to eliminate some ads from candidate lists during ad auctions. For example, as described above, when conducting an ad auction, a list of candidate ads is determined and ranked according to a rank score. To counter the potential problem of under reporting, ads may be removed from the candidate list if they have an unreasonably low bid value, an unreasonably low action rate, or an unreasonably low rank score. As described above, if an advertiser under-reports the number of actions, their action rate will drop, which will also lower their rank score. The advertiser could then increase the bid value to raise the rank score, and continue to under-report. By removing ads with low action rates, the advertisers are prevented from increasing their rank score by simply submitting higher bid values.

For advertisers who choose to under-report, they will likely eventually discover that their ads are not winning ad auctions as anticipated. They may then choose to close their account and open a new account where they can again submit ads and under-report to continue to receive a higher return on their investment. To counteract this behavior, the search engine provider compares new accounts to old accounts in an effort to identify new accounts that are being created to replace previous accounts. One technique for identifying new and corresponding old accounts is to compare the billing information between the accounts. For example, if two accounts use the same credit card number, it is fairly safe to assume that the two accounts are owned by the same advertiser.

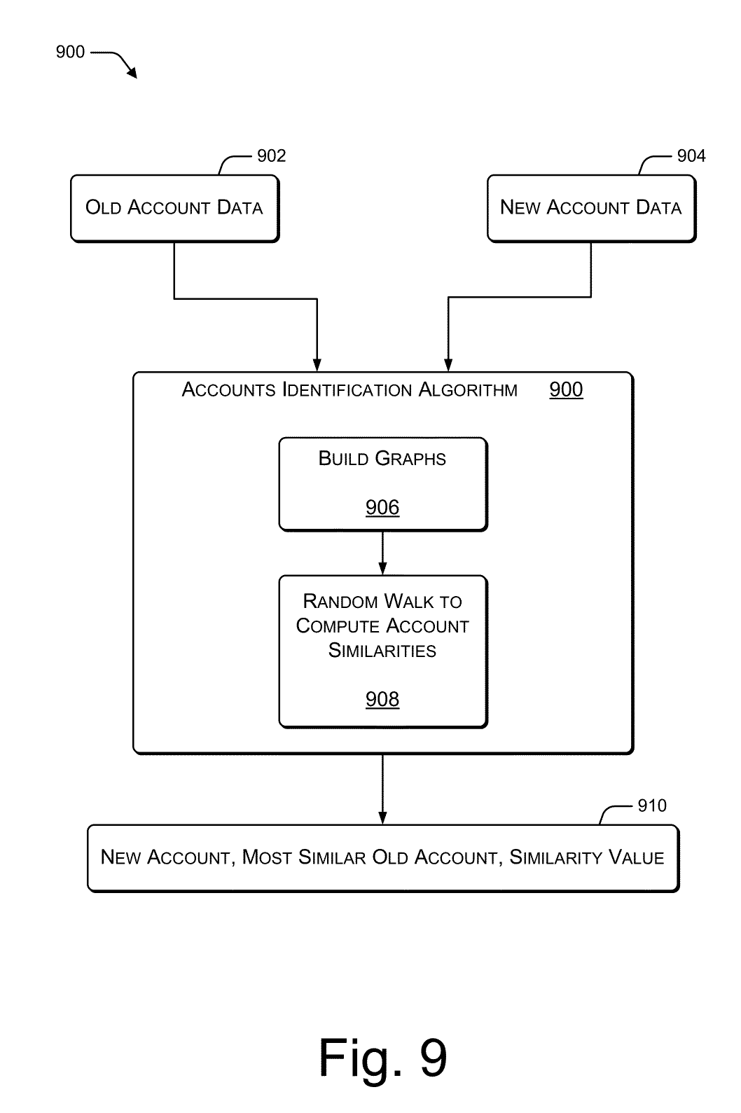

FIG. 9 illustrates an example accounts identification algorithm 900 that may be used to identify old accounts that correspond to new accounts.

According to an example accounts identification algorithm, a set of old accounts 902 including their ad data and their billing data and a set of new accounts 904 also including their ad data and their billing data are input to the algorithm.

The algorithm then builds one or more graphs 906 to represent the similarity between accounts. Example graphs that may be built include, but are not limited to, a bipartite graph between accounts and their landing pages, a bipartite graph between accounts and the domains of their ad landing pages, a bipartite graph between accounts and their bid keywords, a bipartite graph between accounts and the terms in their ad copies. Additionally, a link graph between accounts may be created such that each account is a node and each directed edge represents a hyperlink from the website of the source account to the website of the destination account. Furthermore, a browsing graph may be created such that each account is a node and each directed edge indicates that there is a browsing path from the website of the source account to the website of the destination account.

After the desired graph(s) are built, a similarity between two accounts is computed according to a random walk on the created graph(s) 908. The output 910 from the algorithm is for each new account, an identification of a most similar old account.

In an example implementation, if the similarity between a new account and its most similar old account is larger than a threshold value, a comparison is then made between ads or groups of ads in the new account and ads or groups of ads in the old account. If the ads and/or ad groups are determined to be very similar (e.g., within a threshold value), then for each ad in the new account that has a corresponding ad in the old account, the action rate for the ad in the new account is initialized based on the action rate of the corresponding ad in the old account. Accordingly, the ad in the new account will be subject to the negative effects of the action rate that resulted from the advertiser's under-reporting in the old account.

According to the cost-per-action model described herein, advertisers with a desire to optimize their payoff will not benefit from under-reporting. In other words:

$${lim}_{T -> ∞} \frac{{u}_{T} ( {s}^{*} ) - {u}_{T} ( s )}{T} \geq 0$$

where T is the number of auctions, u_{T}(s*) is an advertiser's payoff when truthfully reporting actions, and u_{T}(s) is the advertiser's payoff when under reporting actions.

If an assumption is made that advertisers will bid their true value, as opposed to submitting excessively high bids, it can be shown that truthful bidding and truthful reporting will result in the best payoff for an advertiser. This may be expressed as:

$${lim}_{T -> ∞} \frac{{u}_{T} ( {b}^{*} , {s}^{*} ) - {u}_{T} ( b , s )}{T} \geq 0$$

where T is the number of auctions, u_{T}(b*,s*) is an advertiser's payoff when truthfully bidding and truthfully reporting actions, and u_{T}(b,s) is the advertiser's payoff with any other bidding and reporting strategy.

Rather than under-reporting, some advertisers may be inclined to over-report actions in an effort to increase their action rate and thus win more ad auctions. At first glance this may seem to be a positive scenario for the search engine provider as the revenue of the search engine provider would increase. However, this type of over-reporting may result in low quality ads (with an artificially high action rate) being highly ranked, and thus winning a large number of ad auctions. This may result in at least two negative consequences. First, search engine users will be presented with lower quality ads, and over time, may choose to move to a different search engine. Second, advertisers who truthfully report their actions may see a reduction in their rate of auction wins, which will seem unfair. As a result, advertisers may choose to move their ad campaigns to a different search engine provider. These consequences would lead to reduced revenue for the search engine provider.

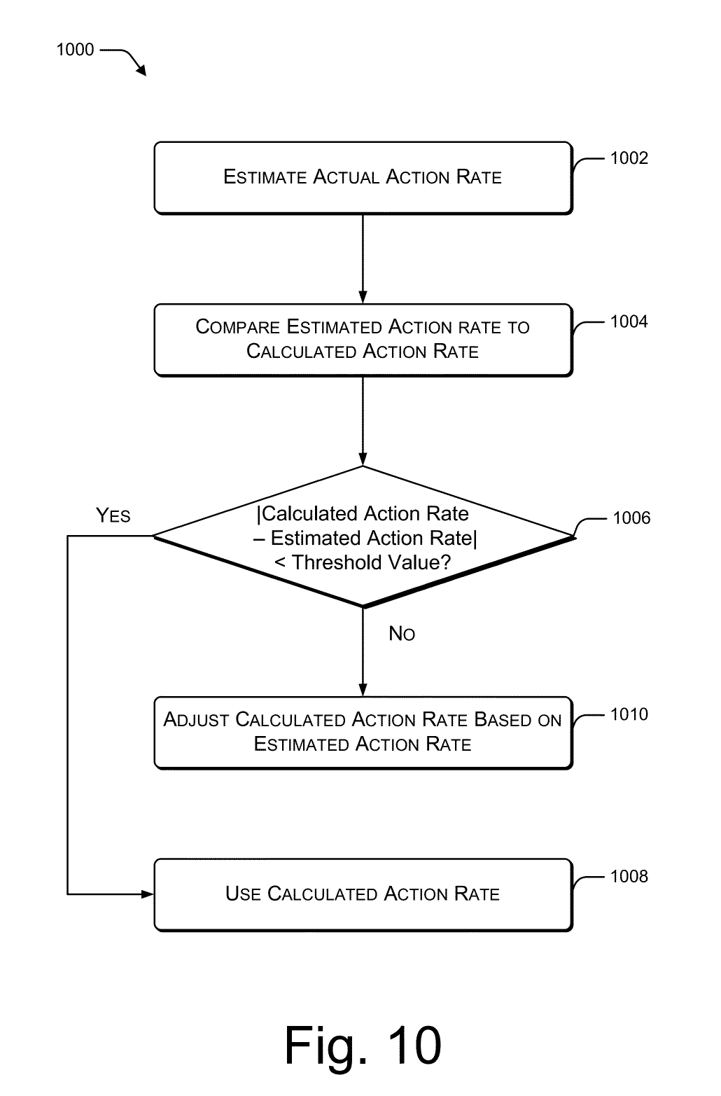

FIG. 10 illustrates an example process 1000 that may be implemented to counteract advertiser over-reporting.

At block 1002, the search engine provider estimates an actual action rate associated with an ad.

At block 1004, the search engine provider compares the estimated action rate with the action rate calculated based on the reported actions.

At block 1006, a determination is made as to whether or not the difference between the estimated action rate and the calculated action rate is less than a threshold value. If the difference is less than the threshold value (the “Yes” branch from block 1006) then at block 1008, the search engine provider continues processing as normal, using the calculated action rate.

On the other hand, if at block 1006, it is determined that the difference between the estimated action rate and the calculated action rate is not less than the threshold value (the “No” branch from block 1006), then at block 1010, the calculated action rate is adjusted based on the estimated action rate. In an example implementation, if the calculated action rate deviates from the estimated action rate by more than the threshold value, a new action rate may be calculated according to:

AR_{i,t}*=AR_{i,t}*D_{ε}(|AR_{i,t}−θ_{i,t}|)

where θ_{i,t} is the estimated action rate for ad i during time period t and:

$${D}_{ε} ( x ) = \{ \begin{matrix}1 & if x \leq ε \\ δ ( x ) & otherwise\end{matrix}$$

where δ(x) is a decreasing function that takes a value between 0 and 1. Accordingly, the rank score for ad i at time period t (RSi,t) is given by:

RS_{i,t}=b_{i,t}*AR_{i,t}*D_{ε}(AR_{i,t},θ_{i,t})

According to this approach, the greater the variance between the calculated action rate (AR_{i,t}) and the estimated action rate (θ_{i,t}), the smaller the value of D_{ε}(AR_{i,t},θ_{i,t}), and thus the more the calculated action rate will be reduced.

The process described with reference to FIG. 10 relies on the search engine provider's ability to estimate the actual action rate associated with a particular ad. A variety of techniques may be employed to estimate the action rate. In an example implementation, various features associated with the cost-per-action ads are extracted. A linear regression model is then used to estimate the action rate for the cost-per-action ads. The linear regression model may first be trained using a set of training data for which the action rates are known. For instance, in one example implementation, given a training set of n ads for which action rates are known, for ad i, yᵢ represents the action rate and xᵢ represents the ad's feature vector. Using the training data, a weight vector β* is learned, which can be used to predict yᵢ using xᵢ according to:

β*=minΣᵢ₌₁ⁿ(yᵢ−β^{T}xᵢ)²

where β^{T} represents the transpose of vector β and β^{T}xᵢ represents the inner product of the two vectors, β and xᵢ. Then, for a new ad with feature vector xⱼ, the actual action rate yⱼ is estimated as:

In addition to features associated with the cost-per-click ads, log data may be leveraged to further improve the process for estimating an actual action rate. Log data may include web browser activity logs, web browser toolbar logs, and any other types of data that may be available to the search engine provider, either directly or through a third-party. In an example implementation, one or more specific webpages within an advertiser's website are each identified as a page on which an action may occur. For example, a page may be identified as a conversion page (i.e., a page on which an action may occur) based on the occurrence of one or more specific keywords on the web page. Examples of such keywords include, but are not limited to, “checkout”, “confirm”, “order”, “cart”, “thank”, “regist”, “receipt”, “success”, “finish”, “conversion”, “complete”, and “signup”.

Any combination of one or more of the following statistics are then analyzed for the website to estimate actual action rates associated with particular ads: number of visits on the landing page, number of unique visitors on the landing page, total dwell time on the landing page, average dwell time on the landing page, number of visits on the website, number of unique visitors on the website, total dwell time on the website, average dwell time on the website, number of visits on the conversion pages in the website, number of unique visitors on the conversion pages in the website, total dwell time on the conversion pages in the website, and average dwell time on the conversion pages in the website.

By addressing the possibility of advertiser over-reporting or under-reporting, possible risks that may be perceived by advertisers choosing to adopt the cost-per-action model described herein are minimized.

### CONCLUSION

The cost-per-action model described herein provides an alternative to cost-per-impression or cost-per-click models, while enabling advertisers to maintain the privacy of detailed transaction information. Rather than directly monitoring actions on advertisers' websites, the described cost-per-action relies on advertiser-reported actions to determine the cost-per-action fees that will be charged to the advertisers. Furthermore, a cost-per-action/cost-per-click hybrid model is also described that equally supports both the described cost-per-action model and a more common cost-per-click model. The hybrid model allows advertisers to choose whether to submit cost-per-action ads, cost-per-click ads, or both.

Although the subject matter has been described in language specific to structural features and/or methodological operations, it is to be understood that the subject matter defined in the appended claims is not necessarily limited to the specific features or operations described. Rather, the specific features and acts are disclosed as example forms of implementing the claims.

What is claimed is:

1. A method comprising:
receiving a plurality of ads, each ad being associated with an action, a bid value, and a keyword;
receiving, by a computer-based search engine provider, a search query;
at least partly in response to receiving the search query:
conducting an ad auction to select, from the plurality of ads, one or more contextually relevant ads to return with results of the search query, a particular ad being selected as the winning ad of the ad auction; and
returning the results of the search query and the winning ad;
receiving an indication that the winning ad has been selected by a user;
receiving from an advertiser from whom the winning ad was received, a report indicating that the action associated with the winning ad has occurred; and
at least partly in response to receiving the report, charging the advertiser a fee for the winning ad.

2. A method as recited in claim 1, wherein conducting the ad auction comprises:
comparing the search query to the keywords associated with the plurality of ads to generate a list of candidate ads, the list of candidate ads being a subset of the plurality of ads;
for each ad in the list of candidate ads, calculating a rank score;
ordering the list of candidate ads according to the rank scores; and
identifying a highest ranked candidate ad as the winning ad of the ad auction.

3. A method as recited in claim 2, wherein for each candidate ad, the rank score represents an expected revenue from the candidate ad.

4. A method as recited in claim 2, wherein for each candidate ad, the rank score is equal to the bid value associated with the candidate ad multiplied by an action rate associated with the candidate ad.

5. A method as recited in claim 4, wherein the action rate is based at least in part on a ratio of a number of reported actions to a number of times the candidate ad has been selected by a user.

6. A method as recited in claim 4, wherein the action rate is initialized based at least in part on a machine learning method.

7. A method as recited in claim 4, wherein:
in an event that the candidate ad has not previously been a winning ad of an ad auction, the action rate associated with the candidate ad is an initial action rate determined according to a machine learning method; and
in an event that the candidate ad has previously been a winning ad of at least one ad auction, the action rate associated with the candidate ad is calculated based at least in part on the initial action rate associated with the candidate ad, a ratio of a number of previously reported actions associated with the candidate ad to a number of previously received indications of user selection of the candidate ad, and a tradeoff factor.

8. A method as recited in claim 8, wherein:
the tradeoff factor is a function of time that increases toward 1 over time; and
the action rate is equal to a sum of a first value and a second value, the first value being the tradeoff factor multiplied by the ratio, and the second value being the initial action rate multiplied by a difference between 1 and the tradeoff factor.

9. A method as recited in claim 1, wherein charging the advertiser a fee for the ad at least partly in response to receiving the report comprises:
identifying a time period within which the reported action occurred;
determining a total number of reported actions associated with the winning ad during the time period;
determining a price to be charged to the advertiser for each reported action within the time period; and
charging the advertiser a fee equal to the price multiplied by the total number of reported actions associated with the winning ad during the time period.

10. A method as recited in claim 9, wherein the price to be charged to the advertiser for each reported action within the time period is an average auction price, and calculating the average auction price comprises:
each time the particular ad is a winning ad, determining an auction price for the particular ad;
calculating an accumulated price for the particular ad as a sum of auction prices for the particular ad during the time period;
determining a number of times a user has selected the particular ad during the time period; and
calculating the average auction price as the accumulated price divided by the number of times a user has selected the particular ad during the time period.

11. A method as recited in claim 10, wherein for a particular auction, the auction price for the particular ad is calculated according to a second-price rule.

12. A method comprising:
receiving from one or more advertisers, a plurality of ads including:
one or more ads that are classified as a cost-per-click ad; and
one or more ads that are classified as a cost-per-action ad;
receiving a search query;
at least partly in response to receiving the search query:
conducting an ad auction to identify, from the plurality of ads, a winning ad that is contextually relevant to the search query; and
returning search results and the winning ad;
receiving an indication that the winning ad has been selected by a user;
in an event that the winning ad is classified as a cost-per-click ad, charging an advertiser that submitted the winning ad according to a cost-per-click model; and
in an event that the winning ad is classified as a cost-per-action ad, charging an advertiser that submitted the winning ad according to a cost-per-action model.

13. A method as recited in claim 12, wherein conducting the ad auction comprises:
comparing the search query to keywords associated with each of the one or more ads that are classified as a cost-per-click (CPC) ad to generate a list of candidate CPC ads that are contextually relevant to the search query;
for each CPC ad in the list of candidate CPC ads, calculating a CPC rank score that is based on an anticipated click-through rate and a bid associated with the CPC ad;
comparing the search query to keywords associated with each of the one or more ads that are classified as a cost-per-action (CPA) ad to generate a list of candidate CPA ads that are contextually relevant to the search query;
for each CPA ad in the list of candidate CPA ads, calculating a CPA rank score that is based on an anticipated action rate and a bid associated with the CPA ad;
combining the list of candidate CPC ads with the list of CPA ads to generate a complete list of candidate ads;
ordering the complete list of candidate ads by rank score, wherein the CPC rank score is used for the cost-per-click ads and the CPA rank score is used for the cost-per-action ads; and
selecting an ad with a highest rank score as the winning ad.

14. A method as recited in claim 13, wherein:
in an event that a particular ad is classified as both a CPA ad and as a CPC ad and is in the list of candidate CPC ads and in the list of candidate CPA ads, removing the CPA ad or the CPC ad, whichever has the lower rank score.

15. A method as recited in claim 12, wherein charging an advertiser that submitted the winning ad according to a cost-per-action model comprises:
maintaining, for a time period, a number of selected impressions that represents an accumulated number of times the wining ad is selected after being returned with search results;
maintaining, for the time period, an accumulated price that represents a sum of prices determined for the winning ad each time the winning ad wins an ad auction;
calculating an average ad price as a ratio of the accumulated price to the number of selected impressions;
receiving a reported number of actions attributed to the winning ad within the time period; and
charging the advertiser a fee equal to the average ad price multiplied by the reported number of actions.

16. A method as recited in claim 14, wherein the price determined for the winning ad is based on a second price rule.

17. A method as recited in claim 14, wherein the price determined for the winning ad is a minimum bid value that will enable the winning ad to win the ad auction.

18. A system comprising:
a search engine configured to:
receive a query;
search for content related to the query; and
return query results that include the content related to the query;
an ad auction processing component configured to:
receive cost-per-action (CPA) ads from advertisers; and
at least partly in response to the search engine receiving the query:
compare the query to keywords associated with the CPA ads to identify candidate ads that are contextually relevant to the query;
conduct an ad auction based at least in part on bid values associated with the candidate ads; and
select a winning ad from the candidate ads, the winning ad being returned by the search engine along with the query results; and
an ad billing component configured to:
receive action reports from the advertisers, at least one action report indicating at least one action attributed to the winning ad; and
for each action attributed to the winning ad, charge the advertiser from whom the winning ad was received a fee based at least in part on the bid value associated with the winning ad.

19. A system as recited in claim 18, wherein:
the ad auction processing component is further configured to:
receive cost-per-click (CPC) ads from advertisers; and
at least partly in response to the search engine receiving the query, compare the query to keywords associated with the CPC ads to identify additional candidate ads that are contextually relevant to the query; and
the ad billing component is further configured to:
receive an indication that a user has selected a winning CPC ad that was returned with query results; and
charge the advertiser a fee for the winning CPC ad based at least in part on a cost-per-click model.

20. A system as recited in claim 19, wherein the ad auction processing component is further configured to:
calculate a CPA rank score for each of the CPA ads identified as a candidate ad, the CPA rank score equal to a bid value of the CPA ad multiplied by an action rate associated with the CPA ad;
calculate a CPC rank score for each of the CPC ads identified as a candidate ad, the CPC rank score equal to a bid value of the CPC ad multiplied by a click-through rate associated with the CPC ad;
collectively order the CPA candidate ads and the CPC candidate ads according to the CPC rank scores and the CPA rank scores; and
select an ad having a highest rank score as the winning ad.
